(19) United States
(12) Patent Application Publication
(10) Pub. No.: US 2013/0222286 A1
(43) Pub. Date: Aug. 29, 2013

(54) DEVICE HAVING TOUCH DISPLAY AND METHOD FOR REDUCING EXECUTION OF ERRONEOUS TOUCH OPERATION

(71) Applicant: Pantech Co., Ltd., (US)

(72) Inventors: Yoon-Koo Kang, Ansan-si (KR); Seuyng-Hwan An, Goyang-si (KR); Hui-Suk Jung, Seoul (KR)

(73) Assignee: Pantech Co., Ltd., Seoul (KR)

(21) Appl. No.: 13/706,880

(22) Filed: Dec. 6, 2012

(30) Foreign Application Priority Data
Feb. 29, 2012 (KR) 10-2012-0021396

(51) Int. Cl. G06F 3/041

(52) U.S. Cl. CPC G06F 3/041
USPC 345/173

(57) ABSTRACT

A touch device sets virtual bezel areas along an edge of a touch panel. If a change in orientation is detected in the touch device, the virtual bezel area may be set to be disposed on each edge of the touch device and may increase in size. The touch device determines if a touch input is a careless touch event according to the location of the virtual bezel area and reference criterion. A careless touch event may not be processed by the touch device.

### CROSS-REFERENCE TO RELATED APPLICATION

This application claims priority from and the benefit under 35 U.S.C. §119(a) of Korean Patent Application No. 10-2012-0021396, filed on Feb. 29, 2012, which is incorporated herein by reference for all purposes as if fully set forth herein.

### BACKGROUND

1. Field

The following description relates to a user interface, and more particularly, to a touch display-based user interface.

2. Discussion of the Background

A touch display has been used as an input method to replace a variety of input device, such as, a mouse or a keyboard, and has been widely applied to various fields, such as, a personal digital assistant (PDA), a liquid crystal display (LCD), a cathode-ray tube (CRT), banks, government offices, medical equipment, tourist guide information, guide information of government agencies, transportation information, etc. The touch display may be categorized as a resistive touch display, surface-wave touch display, or a capacitive touch display depending on an operating method of the touch display. The physical area of a touch display within a device has been increasing, and many devices have a touch display on a front thereof.

### SUMMARY

Exemplary embodiments of the present invention provide a device to reduce erroneous operations in a touch display, and a method for reducing an erroneous touch operation in a device.

Additional features of the invention will be set forth in the description which follows, and in part will be apparent from the description, or may be learned by practice of the invention.

An exemplary embodiment of the present invention discloses a device, including: a touch display to receive a touch event; and a control unit to set a virtual bezel area of the touch display according to an orientation of the device, to determine if the touch event is a careless touch event according to a location of the touch event with respect to the virtual bezel area, and to not process the touch event if the touch event is determined to be a careless touch event.

An exemplary embodiment of the present invention also discloses a method for reducing execution of a careless touch operation in a touch device, the method including: detecting a touch event in the touch device; determining if the touch event is a careless touch event; and processing the touch event if the touch event is not a careless touch event.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram of a device according to exemplary embodiments of the present invention.

FIG. 2 is a diagram illustrating various user grasps of a device according to exemplary embodiments of the present invention.

FIG. 3 is a diagram of a device according to exemplary embodiments of the present invention.

FIG. 4 is a diagram of a control unit of FIG. 3.

FIG. 5 is a flowchart of a method for reducing an erroneous touch operation according to exemplary embodiments of the present invention.

FIG. 6A and FIG. 6B are diagrams illustrating a touch display screen of a device according to exemplary embodiments of the present invention.

FIG. 7A and FIG. 7B are diagrams of a touch display screen of a device according is to exemplary embodiments of the present invention.

FIG. 8 is a diagram of various touch display screen according to exemplary embodiments of the present invention.

FIG. 9 is a diagram illustrating various user grasps of a touch display screen of a device according to exemplary embodiments of the present invention.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements. Although features may be shown as separate, such features may be implemented together or individually. Further, although features may be illustrated in association with exemplary embodiments, features for one or more exemplary embodiments may be combinable with features from one or more other exemplary embodiments.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

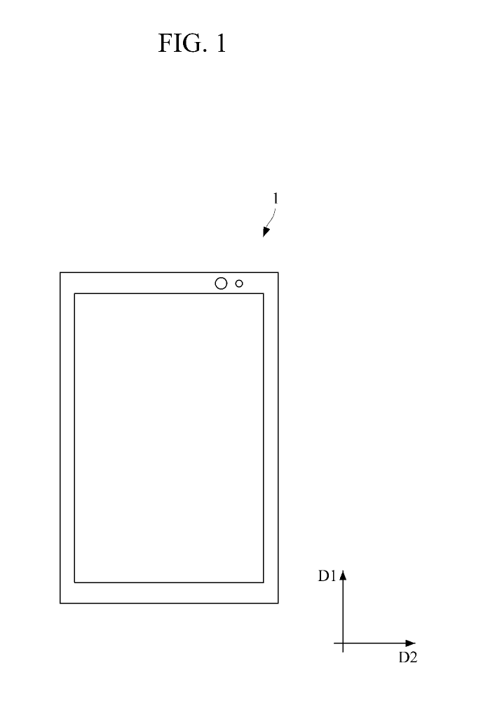

FIG. 1 is a diagram of a device according to exemplary embodiments of the present invention.

Referring to FIG. 1, a device 1 may be a user interface device including an input unit to receive an input signal and an output unit to display a processing result corresponding to the input signal. The input signal may be received from a user touch on the interface device. The input unit and the output unit may be located in the same physical area, which may be a touch display panel.

The touch display panel may be a full-screen of the device 1 in which most of the area of one side of the device 1 may be used as a display area and a bezel area around the full-screen may be reduced. The bezel area refers to an area of the touch display panel surrounding an active or touch area or disposed at an edge of the active or touch area of the touch display. The active area refers to an area which may display an image on a screen and/or receive a touch input. The active area refers to an area of the display panel that includes pixels and may display an image. There may be a difference between a touch display panel size and a size of an active area because of wiring and margins at the boundary of the touch display panel. The bezel area refers to an area which may include pattern lines at the right, left, top, and bottom, i.e., edges, of the touch display panel of the device 1. A touch display panel with a reduced bezel area has been used in the device 1 as a full screen touch display.

In the full-screen touch display, an area that can receive user touch signals or inputs has increased and the size of a touchable area may increase accordingly, and a bezel area, which can be held or gripped by a user, may decrease, such that touch-related issues, which may not occur while the user grips or grasps a device with a larger bezel, may occur. For example, if the user intends to grip the device 1, the user may touch the active area as well as the bezel area. Due to such unintentional touch, the possibility of erroneous operation of a device may increase. The erroneous operation may refer to various operations that are caused by user's unintentional touch and thus cause the device to perform an operation not intended by the user. The above-described touch-related issues may lead to a significant problem in use of the device 1.

The device 1 may be any type of device that includes a touch display panel. The device 1 may be, for example, a cellular phone, a personal digital assistant (PDA), a wireless communication device, a portable device, a laptop computer, a tablet computer, a cordless phone, etc. The device 1 may be a portable multifunctional device, such as, a smart phone, a smart pad, etc.

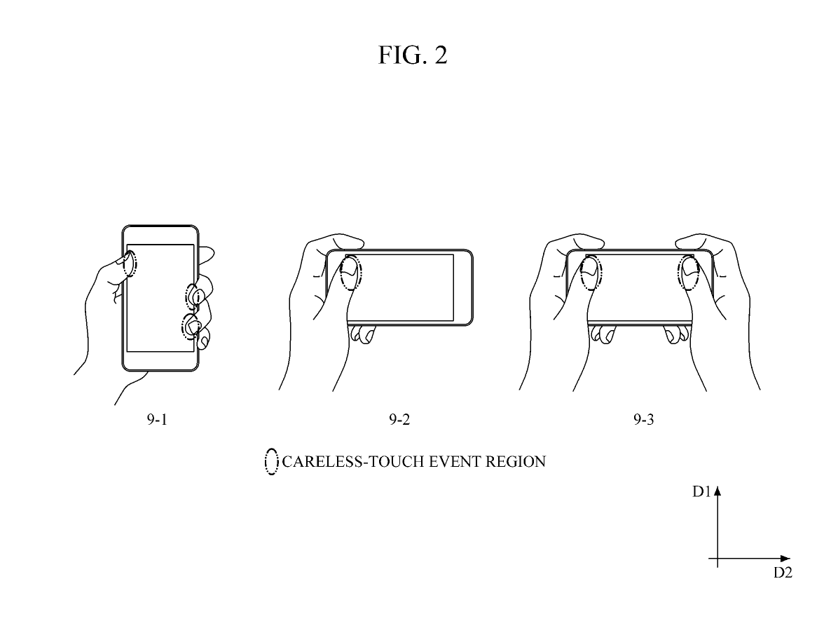

FIG. 2 is a diagram illustrating various user grasps of device according to exemplary embodiments of the present invention.

As described with reference to FIG. 1, because of a reduced bezel area of the device 1, the user is more likely to touch the device 1 near the active area or in the active area when grasping or gripping the device 1. A user's action that touches near or directly on the active area may cause an unintentional operation of the device 1 and may be referred to as a “user's careless grasp.” Hereinafter, examples of “users' careless grasps” will be described with reference to images in FIG. 2.

Referring to FIG. 2, image 9-1 illustrates an example of a user's careless grasp in portrait mode of the device 1, in which long edges of the device 1 are disposed vertically, i.e., the long edges of the device 1 are disposed in a vertical direction D1 and short edges of the device 1 are disposed in a horizontal direction D2 Image 9-2 and image 9-3 in FIG. 2 illustrate examples of a user's careless grasp in landscape mode of the device 1, in which the long edges of the device 1 are disposed horizontally, i.e., the long edges of the device 1 are disposed in the horizontal direction D2 and the short edges of the device 1 are disposed in the vertical direction D1. Although illustrated as having long edges and short edges, device 1 need not be limited thereto such that the device 1 may have edges of equal or similar length and the user's careless grasps may be similarly applied to the device 1 having edges of equal or similar length. Furthermore, although illustrated as a polygon with four sides, the device 1 need not be limited thereto, and the device 1 may have any number of sides or curves, for example, the device 1 may be have a triangular shape or a circular shape.

A conductive object, such as, a user's hand, is illustrated in a touch display panel of the device 1 in image 9-1, image 9-2, and image9-3 of FIG. 2. Circled regions indicate a careless touch event region, an area in which a careless touch event may be generated by the user's touch. If the careless touch event occurs in the circled regions, the device 1 may operate erroneously. If one touch event is validated in the touch display of the device 1 at a time, a user's desired touch event may not be processed if a careless touch event is occurring or has already occurred in the device 1, and the device 1 may be locked, i.e., the device 1 may not be able to receive a touch event in addition to or after the careless touch event.

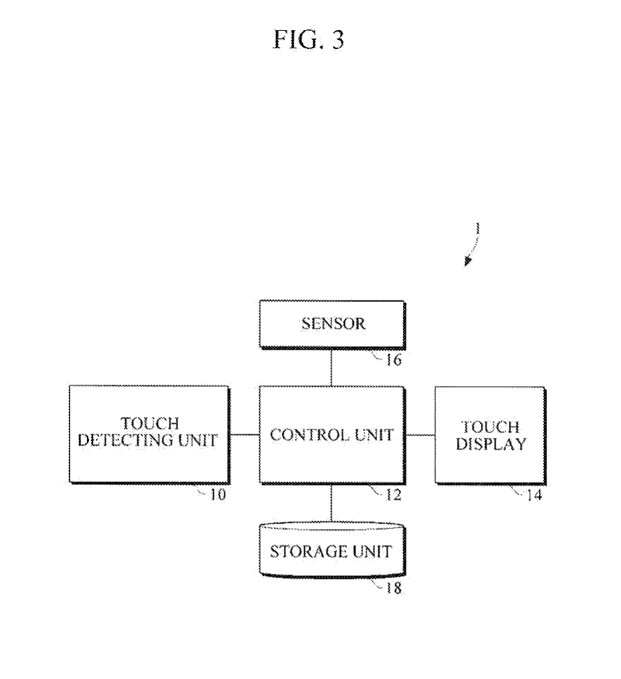

FIG. 3 is a diagram of a device according to exemplary embodiments of the present invention.

Referring to FIG. 3, the device 1 may include a touch detecting unit 10, a control unit 12, and a touch display 14. The device 1 may further include a sensor 16 and a storage unit 18.

The touch detecting unit 10 may detect a touch event on the touch display 14. The touch display 14 may display a touch event processing result of the control unit 12. The touch detecting unit 10 and the touch display 14 may be formed in the same physical area.

The control unit 12 may control the components of the device 1. The control unit 12 may process the touch event detected by the touch detecting unit 10. The control unit 12 may set a virtual bezel area that is different from a physical bezel area of the touch display 14, and may not process a touch event that is detected as occurring in the virtual bezel area. If a touch event occurs within the virtual bezel area, it may not be processed and may be invalidated. This may prevent the execution of an erroneous operation detected in the virtual bezel area, which may be caused by user's careless grasp. The control unit 12 may be a processor.

The control unit 12 may change the virtual bezel area according to device mode. The device mode may include landscape mode in which a screen of the device 1 is displayed in a horizontal orientation (i.e., the long edges of the device 1 are disposed in the horizontal direction D2), a portrait mode in which the screen is displayed in a vertical orientation (i.e., the long edges of the device 1 are disposed in the vertical direction D1), and a transit mode in which the displaying orientation is switched from landscape to portrait or vice versa (i.e., the long edges of the device 1 are being moved from one of the vertical direction D1 and the horizontal direction D2 to the other of the vertical direction D1 and the horizontal direction D2 or the long edges of the device 1 are disposed between the vertical direction D1 and the horizontal direction D2). The device mode may be determined using device state information obtained from the sensor 16. The sensor 16 may generate a sensing signal according to the device state information, for example, whether the device 1 is positioned in a horizontal orientation, a vertical orientation, or therebetween, may be identified. The sensor 16 may be a gyro sensor, an acceleration sensor, a geomagnetic sensor, etc. In response to the sensor 16 acquiring the device state information, the control unit 12 may set the device mode using the device state information.

The storage unit 18 may store and manage data associated with the virtual bezel area. The storage unit 18 may store and manage the device state information obtained from the sensor 16. If the device state information is updated, the storage unit 18 may transmit the updated device state information to the control unit 12. The control unit 12 may alter the virtual bezel area using the updated device state information. Data associated with the altered virtual bezel area may be stored in the storage unit 18.

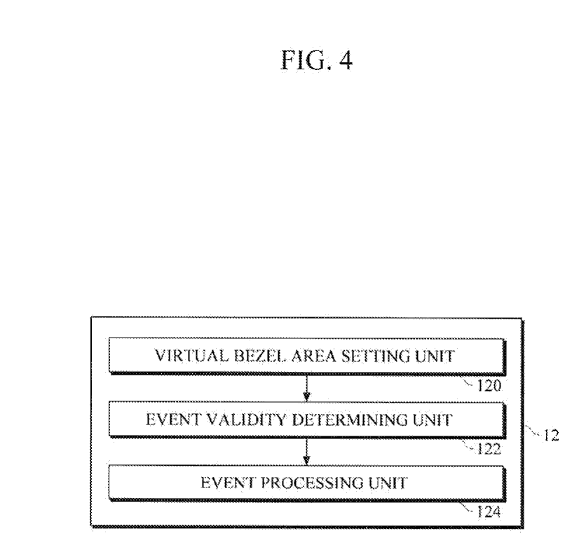

FIG. 4 is a diagram of the control unit of FIG. 3.

Referring to FIG. 4, the control unit 12 may include a virtual bezel area setting unit 120, an event validity determining unit 122, and an event processing unit 124.

The virtual bezel area setting unit 120 may set a virtual bezel area. The virtual bezel area may be a virtual area that is formed on or at an edge of a touch display 14, and may be separate from a physical bezel area that is formed on or at an edge of the touch display 14. The physical bezel area may be an outer edge of the touch display 14 and the virtual bezel area may be an inner edge of the touch display 14, i.e., the virtual bezel area may be an outer edge of an active area of the touch display 14, the active area being an area in which images are displayed and touches are received, and the physical bezel area may be disposed at an outer edge of the active area of the touch display 14.

The virtual bezel area setting unit 120 may activate or deactivate the virtual bezel area according to a change in the user's grasp or the device mode. The device mode may be determined by the position of the device 1 being grasped by the user, and may be one of the landscape mode, the portrait mode, and the transit mode.

The virtual bezel area setting unit 120 may determine the device mode using the device state information, and may alter the virtual bezel area according to the device mode.

For example, in response to the change in the device mode, the virtual bezel area setting unit 120 may alter the virtual bezel area to be formed on or at edges of, at least, two sides of the touch display 14 of the device 1 positioned perpendicular to the orientation of the device mode, i.e., the virtual bezel area setting unit 120 may alter the virtual bezel area to be formed on or at edges of the touch display 14 of the device 1 disposed in the vertical direction D1.

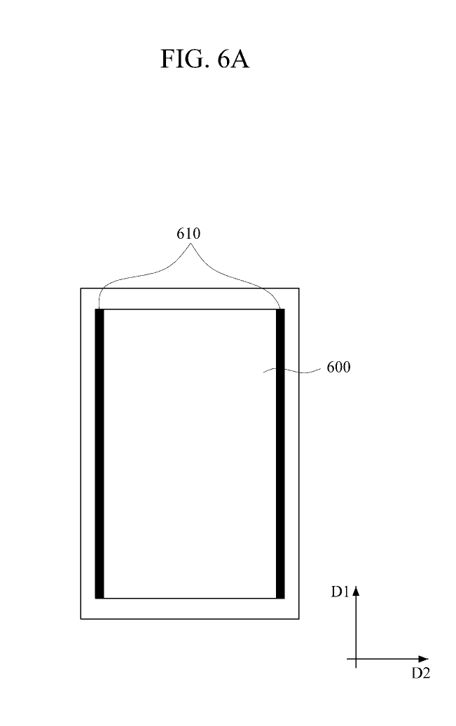

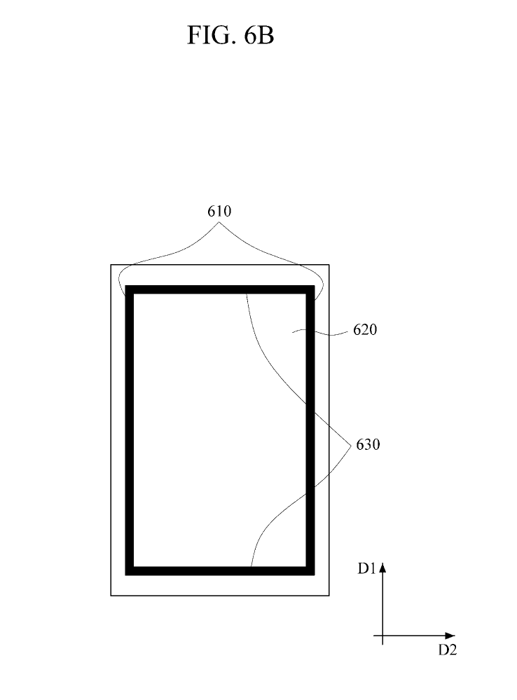

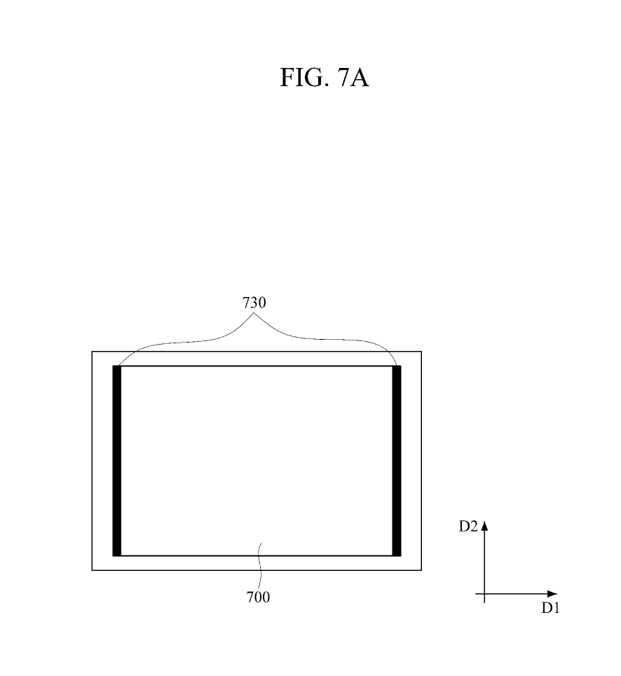

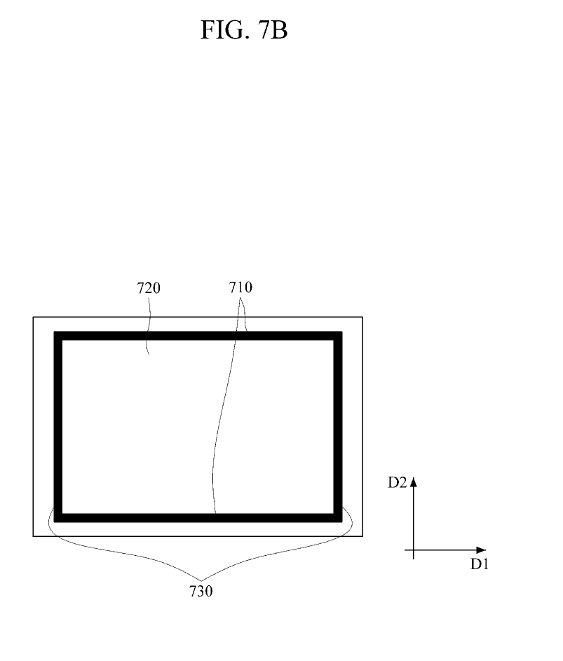

Examples of altering of the virtual bezel area will be described in detail with reference to FIG. 6A, FIG. 6B, FIG. 7A, and FIG. 7B. The device state information may be information to determine whether the device 1 is positioned in a horizontal orientation, a vertical orientation, or therebetween, and may be acquired by the sensor 16 of the device 1.

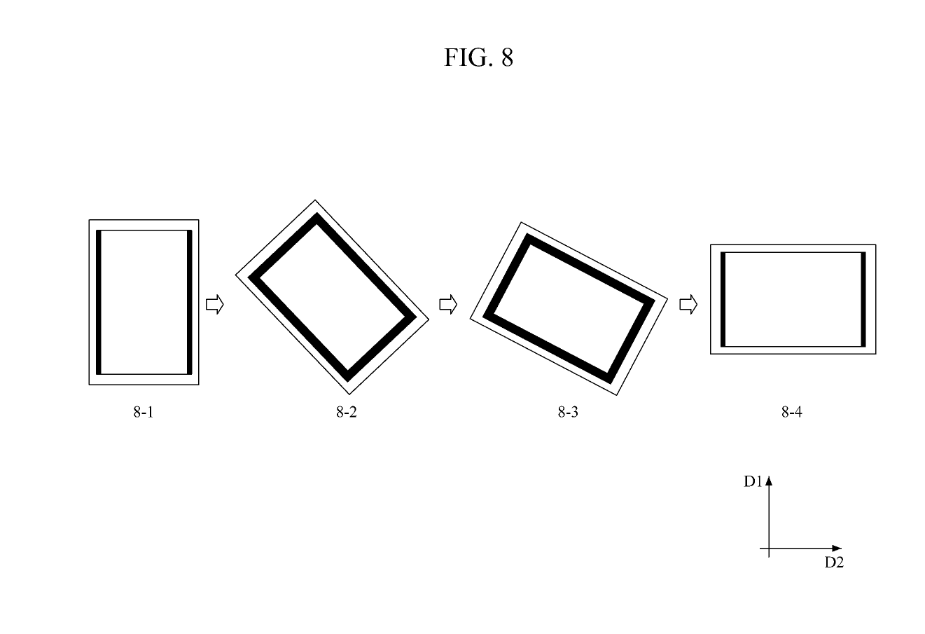

The virtual bezel area setting unit 120 may expand the virtual bezel area during the transit mode of the device mode in which the device 1 may be switched from landscape mode to portrait mode or vice-versa or in which the edges of the device 1 are disposed in directions other than the vertical direction D1 and the horizontal direction D2. The expansion of the virtual bezel area will be described with reference to FIG. 8.

The event validity determining unit 122 may determine the validity of the touch event by detecting whether a touch event occurs in relation with the virtual bezel area based on a location of the touch event being input. Herein, the expression “a touch event in relation with the virtual bezel area” may be used to refer to situations in which a touch event occurs in both the active area and the virtual bezel area, within the virtual bezel area, near the virtual bezel area, or in both the virtual bezel area and outside the virtual bezel area, and in which a normal touch event may occur in the touched region.

The event validity determining unit 122 may determine whether a touch event occurs in relation with the virtual bezel area. If the touch event occurs in relation with the virtual bezel area, the event validity determining unit 122 may further determine whether a touch of the touch event within the virtual bezel area meets a reference criterion. If it is determined that the touch event meets the reference criterion, the event validity determining unit 122 may make a determination that the touch event will cause an erroneous operation of the device.

The reference criterion may be, for example, one of three criterion: (1) if a range of a touch movement of the touch event occurs in the virtual bezel area is greater than a reference range; (2) a length of time for the touch event to occur within the virtual bezel area is greater than a reference length of time, and (3) a magnitude of the pressure of the touch event within the virtual bezel area is greater than a reference pressure magnitude. The three criterion described above are exemplary and the present disclosure is not limited to the three criterion. The reference range, the reference length of time, and the reference pressure magnitude may be set or changed by the device or by the user.

A bezel area may be disposed along the periphery of the device 1, and the careless touch event may occur on the edge of the device 1.

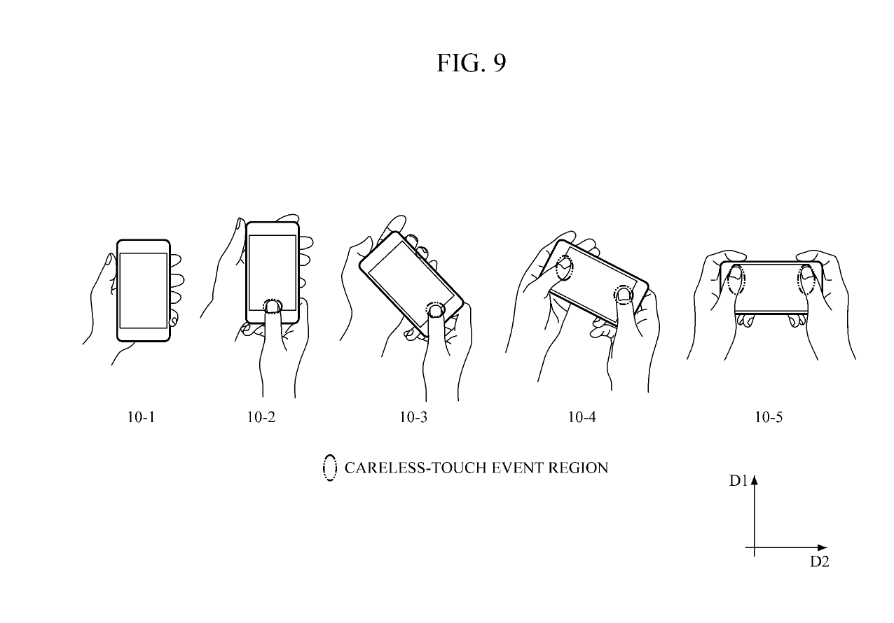

If a touch movement of the touch event occurring in a virtual bezel area is greater than a reference range, the touch event may be discarded or removed from processing or execution. For example, if the user switches the user device 1 from the landscape mode to the portrait mode or vice versa, as shown in FIG. 9, the user may rotate the device 1 while grasping a lower portion of the device 1 with the palm or fingers. While rotating the device 1, the touch movement on the device 1 may have a greater range than the reference range, a range of a general touch movement occurring in the active area. Thus, if a touch movement is detected with a range greater than a reference range, the probability that the user is unintentionally touching the active area may increase. Hence, the touch movement being greater than a reference range of movement may be used as one of the criteria to discard or remove a touch event from processing or execution.

If a touch event occurs in the virtual bezel area and is longer than a reference length of time, the touch event may be discarded. If the user is gripping the device 1 without changes in a touch motion, a length of time of the touch event may be longer than a length of time of a usual touch event occurring in the active area. The touch event with a length of time greater than the reference length of time may be interpreted as the user holding the device 1, for example, to view the display of the device 1 without performing a touch on the device 1. Similarly, if the touch event is detected in the active area of the device 1, the touch event may be discarded because the user may not intend to perform a certain operation through the touch motion.

If a pressure magnitude of a touch event is greater than a reference pressure magnitude value, the touch event may be discarded. For example, if the user is switching the device 1 from the landscape mode to the portrait mode, or vice versa, the device 1 may be touched by the user's fingers or palm, as indicated by oval shapes in FIG. 9. In other words, the range of movement of the touch event during changes in mode may be greater than the range of a usual finger touch movement and its pressure magnitude may also greater than that of the pressure magnitude value of the usual touch event. The probability of the user unintentionally touching the active area of the device may increase during changes in the mode of the device 1, and thus, the pressure magnitude being greater than a reference pressure magnitude value may be used as one of criteria to discard a touch event.

To measure the pressure magnitude of a touch event, the touch panel of the device 1 may be configured to be pressure-sensitive or to be pressure-sensitive capacitive. The pressure-sensitive type touch panel may detect a pressure of user's touch whereas the pres sure-sensitive capacitive type touch panel may utilize capacitance measurement.

The event validity determining unit 122 may determine that a touch event which meets at least one of the aforementioned criteria is a touch event which may cause an erroneous operation of the device 1 due to the user's careless grasping, and may not transmit the touch event to the event processing unit 124. According to the touch event validity determination result, the event validity determining unit 122 may not provide the touch event determined to be a careless touch event, but provides other touch events to the event processing unit 124, thereby reducing the probability that the event processing unit 124 processes the careless touch event. Accordingly, processing of the user's unintentional touch motion may be reduced.

According to the determination result from the event validity determining unit 122, the event processing unit 124 may prevent the touch event that occurs in relation to the virtual bezel area and may cause an erroneous operation of the device 1 from being processed by the device 1.

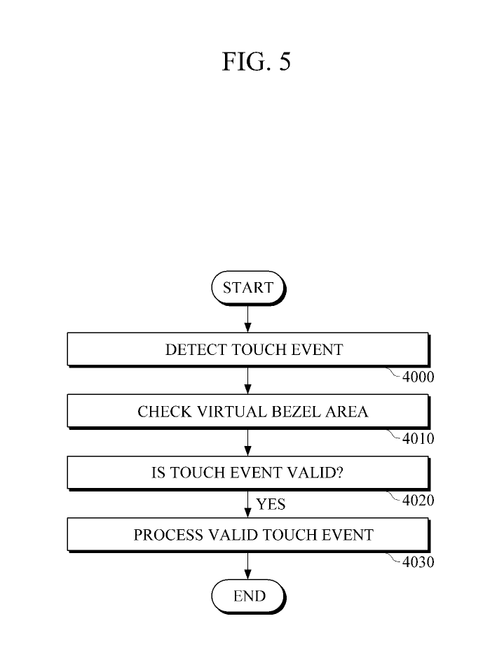

FIG. 5 is a flowchart of a method for reducing an erroneous touch operation of a device according to exemplary embodiments of the present invention. Although the method of FIG. 5 will be described with reference to FIG. 1, the method of FIG. 5 is not limited thereto.

Referring to FIG. 1 and FIG. 5, in operation 4000, the device 1 may detect a touch event input to a touch display.

In operation 4010, the device 1 detects a touch location of a touch event and determines a virtual bezel area of the touch display. The touch location may be indicated by X-Y coordinates of the touch display on which the touch event is occurring. The virtual bezel area may be activated or deactivated depending on the changes in user's grasping motion or device mode. For example, the device 1 may determine the device mode based on device state information, and adaptively change the virtual bezel area according to the determined device mode. The virtual bezel area may be formed on at least two side edges of the touch display, regardless of the determined device mode.

In operation 4020, the device 1 determines the validity of the touch event by determining whether the touch event is input in relation with the virtual bezel area within the touch display and whether the touch event may cause an erroneous operation of the device 1. If it is determined that the touch event is an invalid event, i.e., a careless touch event, that may cause an erroneous operation of the device 1, the device 1 invalidate or does not process the touch event. If it is determined that the touch event is a valid event, in operation 4030, the device 1 may perform a process according to the touch event.

In operation 4020, the device 1 may determine whether the touch event meets a reference criterion. The device 1 may determine the touch event as an invalid event that causes an erroneous operation of the device 1 if the touch event meets the criterion. The criterion may be a touch movement within the virtual bezel area being greater than a reference range of movement, a time length of the touch event within the virtual bezel area being longer than a reference time length, and a pressure magnitude of the touch event within the virtual bezel area being greater than a reference pressure magnitude value.

In operation 4030, the device 1 may discard or not process the touch event that is determined to be an invalid event that may cause an erroneous operation of the device 1. However, the device 1 may process a touch event that occurs within the virtual bezel area if it does not satisfy any of the reference criteria.

FIG. 6A and FIG. 6B are diagrams illustrating a touch display screen of a device according to exemplary embodiments of the present invention. FIG. 6A and FIG. 6B are described to explain how to set virtual bezel areas in portrait mode. Although described with reference to FIG. 4, the features of FIG. 6A and FIG. 6B are not limited thereto.

In portrait mode, a user may grip vertical sides, i.e., sides disposed in the direction D1, of the device 1. Referring to FIG. 4, the virtual bezel area setting unit 120 may set two side edges disposed in the direction D1 inside the touch display to be the virtual bezel areas 610, as illustrated in FIG. 6A. If a touch event occurs within a normal touch event area 600, the event validity determining unit 122 may determine that the touch event is a normal touch event, i.e., not a careless touch event.

Referring to FIG. 6B, the virtual bezel area setting unit 120 may set the other two side edges inside the touch display which are disposed in the direction D1, as virtual bezel areas 630 and activate both virtual bezel area 610 and 630. If a touch event occurs within a normal touch event area 620, the event validity determining unit 122 may determine that the touch event is a normal touch event. The number and size of the virtual bezel areas is not limited and may be any shape to surround the display panel and any number of virtual bezel areas needed to surround each side or edge of the active area of the display panel.

If the user grasps the device 1 carelessly, there may be a careless touch event within the virtual bezel area 610 or the virtual bezel area 630. However, if the unintentional touch event occurs within the virtual bezel area 610 or the virtual bezel area 630, the event validity determining unit 122 may identify the touch event as a careless touch event, and may not transmit the touch event to the event processing unit 124. An erroneous operation of the device 1 due to the user's carelessness may be prevented.

FIG. 7A and FIG. 7B are diagrams of a touch display screen of a device according to exemplary embodiments of the present invention. FIG. 7A and FIG. 7B are depicted to explain how to set virtual bezel areas in landscape mode. Although described with reference to FIG. 4, the features of FIG. 7A and FIG. 7B are not limited thereto.

In landscape mode, a user may grip horizontal sides of the device 1, i.e., sides parallel to the D2 direction. Referring to FIG. 4, the virtual bezel area setting unit 120 may set two side edges inside the touch display parallel to direction D2 as virtual bezel areas 710, as illustrated in FIG. 7A. If a touch event occurs within a normal touch event area 700, the event validity determining unit 122 may determine that the touch event is a normal touch event.

Referring to FIG. 7B, the virtual bezel area setting unit 120 may set may set the other two side edges inside the touch display which are parallel to the direction D2, as virtual bezel areas 730 and activate both virtual bezel area 710 and 730. If a touch event occurs within a normal touch event area 720, the event validity determining unit 122 may determine that the touch event is a normal touch event. The number and size of the virtual bezel areas is not limited and may be any shape to surround the display panel and any number of virtual bezel areas needed to surround each side or edge of the display panel.

If the user grasps the device 1 carelessly, there may be a careless touch event within the virtual bezel area 710 or the virtual bezel area 730. However, if the unintentional touch event occurs within the virtual bezel area 710 or the virtual bezel area 730, the event validity determining unit 122 may identify the touch event as a careless touch, and may not transmit the touch event to the event processing unit 124. An erroneous operation of the device 1 due to the user's carelessness grasp may be prevented.

FIG. 8 is a diagram of a touch display screen according to exemplary embodiments of the present invention. FIG. 8 depicts a device in transit mode being switched from portrait mode to landscape mode and the change in a virtual bezel area during the switch. Although described with reference to FIG. 3 and FIG. 4, the device of FIG. 8 is not limited thereto. Further, although the transit mode may be described as being a mode in which the device is being switched from the portrait mode to the landscape mode, aspects need not be limited thereto such that the transit mode may be a mode in which the edges of the device are not vertical or horizontal.

Referring to FIG. 3, FIG. 4, and FIG. 8, if the user switches the device 1 from portrait mode as shown in image 8-1 to landscape mode as shown in image 8-4, the sensor 16 may detect the change in the mode of the device 1, and may update the device state information. The updated device state information may be transferred to the virtual bezel area setting unit 120, and the virtual bezel area setting unit 120 may expand the virtual bezel areas as illustrated in image 8-2. For example, in image 8-1 the virtual bezel areas may be formed at on two side edges inside the touch display, and in image 8-2 and image 8-3, as the device 1 changes modes, the virtual bezel areas may be expanded to four sides of the touch display including the top and bottom edges inside the touch display. The dimensions of each virtual bezel area, for example a width of the virtual bezel area, may be increased as the device is switched from the portrait mode to the landscape mode. The virtual bezel areas may be expanded because the user is more likely to carelessly touch a larger area of the device during the mode switch.

If the device 1 enters the landscape mode by the user turning the device 1 from the position shown in image 8-3 to the position shown in image 8-4, the virtual bezel area setting unit 120 may set the bezel areas at the two edges of the display parallel to a direction D2. In the case of mode switch from landscape mode to portrait mode, the device 1 may operate in the reverse order, image 8-4 to image 8-3 to image 8-2 to image 8-1.

FIG. 9 is a diagram of a touch display screen of a device according to exemplary embodiments of the present invention. FIG. 9 is depicted to explain careless touch event regions during the device mode switch.

If a user selects to switch the device 1 from portrait mode as shown in image 10-1 to landscape mode as shown in image 10-5, the user may turn the device 1 while holding a lower portion of the device 1 as shown in image 10-2. If the user is holding the lower portion of the device 1 as shown in image 10-2, the device 1 may use the sensor 16 to determine whether the device state information is changed. If it is determined that the device state information has changed, the virtual area setting unit 120 may activate the virtual bezel areas as shown in image 8-2 of FIG. 8. The touch event occurring in the lower portion of the device 1, shown in image 10-2, while the device 1 is rotated may be identified as an invalid touch event that may be caused by the user's carelessness, and hence may be discarded. For example, the touch as shown in image 10-2 of FIG. 2 may be considered a touch in a potential virtual bezel area, or an area adjacent to the bezel area, such that, if a touch is detected in the potential virtual bezel area, the device 1 may determine if the device state information has changed, and, if it is determined that the device state information has changed, the virtual area setting unit 120 of the device 1 may active the virtual bezel area in the potential virtual bezel area and disregard the touch as a careless touch such that the touch in the potential virtual bezel area is not processed. Similarly, if a touch is detected in the virtual bezel area or the potential virtual bezel area, the device 1 may increase a size of the virtual bezel area upon a determination that the device state information has changed.

If there are four virtual bezel areas set in the portrait mode, as illustrated in FIG. 6B, the event validity determining unit 122 may determine whether the touch event occurring at the lower portion as shown in image 10-3 is generated within the virtual bezel area. If the touch event is generated within the virtual bezel area, it is determined whether the touch event is caused by the user's carelessness.

The changes in virtual bezel areas during the mode switch as shown in FIG. 9 may be similar to the mode switch illustrated in FIG. 8. The virtual bezel area setting unit 120 may receive the device state information from the sensor 16, and changes the virtual bezel areas if there is a change in the device state information, such that the user's careless touch may be detected. If the device 1 further rotates and reaches a position shown in 10-5, the virtual bezel area setting unit 120 may change the virtual bezel areas to be suitable for the landscape mode.

According to the exemplary embodiments, the device having a touch display may prevent an erroneous operation caused by a user's unintentional touch on the touch display from being processed by the device, and may thereby improve the usability of the device.

For example, in the case of a full-screen type touch display, more erroneous operations may occur by the user's careless touch movements. According to the exemplary embodiments, however, virtual bezel areas may be set and a touch event occurring within the virtual bezel areas may be discarded from processing, so that the erroneous touch operation due to the user's carelessness may be prevented or reduced, the usability may be increased, and any inconvenience caused by the erroneous operation may also be reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A device, comprising:
a touch display to receive a touch event; and
a control unit to set a virtual bezel area of the touch display according to an orientation of the device, to determine if the touch event is a careless touch event according to a location of the touch event with respect to the virtual bezel area, and to not process the touch event if the touch event is determined to be a careless touch event.

2. The device of claim 1, further comprising:
a sensor to detect the orientation of the device.

3. The device of claim 1, wherein the touch display comprises:
a touch detecting unit to detect the touch event on the touch display.

4. The device of claim 1, wherein the control unit determines that the touch event is a careless touch event according to at least one of a range of movement of the touch event, a length of time of the touch event, a pressure magnitude of the touch event, and the location of the touch event.

5. The device of claim 1, wherein the control unit comprises:
a virtual bezel area setting unit to set an area of the touch display as the virtual bezel area according to the orientation of the device;
an event validity determining unit to determine if the touch event is the careless touch event according to the virtual bezel area; and
an event processing unit to process the touch event if the touch event is determined not to be a careless touch event.

6. The device of claim 5, wherein the event validity determining unit determines the touch event is a careless touch event according to at least one of a range of movement of the touch event, a length of time of the touch event, a pressure magnitude of the touch event, and a location of the touch event.

7. The device of claim 1, wherein the touch display comprises at least one of a pressure-sensitive touch panel and a pressure-sensitive capacitive touch panel.

8. The device of claim 2, wherein, if the sensor unit detects a change in the orientation of the device, the control unit sets the virtual bezel area to be disposed along each side of the device.

9. The device of claim 2, wherein, if the sensor unit detects a change in the orientation of the device, the control unit changes a size of the virtual bezel area of the device.

10. The device of claim 9, wherein, if the sensor unit detects a change in the orientation of the device, the control unit increases the size of the virtual bezel area of the device.

11. The device of claim 1, wherein the control unit sets the virtual bezel area to be disposed along at least one vertical edge of the touch display.

12. A method for reducing execution of a careless touch operation in a touch device, the method comprising:
detecting a touch event in the touch device;
determining if the touch event is a careless touch event; and
processing the touch event if the touch event is not a careless touch event.

13. The method of claim 12, further comprising:
determining a virtual bezel area of the touch device according to the orientation of the touch device.

14. The method of claim 13, wherein the virtual bezel area is disposed along at least one vertical edge of the touch device.

15. The method of claim 12, wherein the determining if the touch event is a careless touch event is according to at least one of the virtual bezel area and a reference criterion.

16. The method of claim 12, wherein the reference criterion is at least one of a range of movement of the touch event, a length of time of the touch event, a pressure magnitude of the touch event, and a location of the touch event.

17. The method of claim 13, wherein, if the orientation of the touch device is changed, the virtual bezel area is disposed at each edge of the touch display while the orientation of the touch device changes.

18. The method of claim 13, wherein, if the orientation of the touch device is changed, the size of the virtual bezel area changes.

19. The method of claim 13, wherein, if the orientation of the touch device is changed, the size of the virtual bezel area increases.

20. The method of claim 13, wherein the virtual bezel area is disposed along each edge of the touch display.

21. The method of claim 13, wherein the determining if the touch event is a careless touch event is according to at least one of a location of the touch event and a change in the orientation of the device.

22. The method of claim 21, wherein, if the orientation of the device is changed, activating the virtual bezel area.

23. The method of claim 22, wherein if the virtual bezel area is activated, increasing the size of the virtual bezel area while the orientation of the device is changing.
